(19) United States
(12) Patent Application Publication
(10) Pub. No.: US 2025/0268155 A1
(43) Pub. Date: Aug. 28, 2025

(54) TREE SKIRT CONVENIENT FOR STOWAGE AND STORAGE

(71) Applicant: Centresky Crafts (Shantou) Co., Ltd, Shantou (CN)

(72) Inventor: Youguo WANG, Shantou (CN)

(73) Assignee: Centresky Crafts (Shantou) Co., Ltd, Shantou (CN)

(21) Appl. No.: 18/609,452

(22) Filed: Mar. 19, 2024

(30) Foreign Application Priority Data
Feb. 23, 2024 (CN) 202420338591.2

(51) Int. Cl. A01G 13/02

(52) U.S. Cl. CPC A01G 13/31

(57) ABSTRACT

A tree skirt convenient for stowage and storage includes: a skirt pieces and a support assembly. Both ends of the skirt piece are connected, and the skirt piece is enclosed to form an inner cavity. The support assembly includes an elastic support ring and a connector, the elastic support ring has a closed ring shape, the elastic support ring is located on an inner surface of the skirt piece, the elastic support ring extends in a circumferential direction of the skirt piece, the connector is detachably connected to the skirt piece, and the elastic support ring is limited between the skirt piece and the connector. The elastic support ring is capable of being twisted and folded to form a double-ring structure to reduce a diameter of the elastic support ring.

### CROSS-REFERENCE TO RELATED APPLICATIONS

This application claims priority to Chinese Patent Application No. 202420338591.2, filed on Feb. 23, 2024, the content of which is incorporated herein by reference in its entirety.

### TECHNICAL FIELD

The present application pertains to the technical field of tree skirts, and specifically pertains to a tree skirt convenient for stowage and storage.

### BACKGROUND

Tree skirts are capable of decorating and protecting plants (e.g., plants such as Christmas trees that foil the festival ambience theme, daily household green plants, etc.). A tree skirt generally includes skirt pieces and a support assembly, the skirt pieces are enclosed to form a closed ring shape, and the skirt pieces extend around the plant. The support assembly is typically a rigid circular ring arranged on an inside surface of the skirt piece to support the skirt piece, so that the skirt piece is maintained in a straight state. However, when it is not necessary to use the tree skirt, and the tree skirt needs to be stowed, it is impossible to change the shape of the support assembly as it is a rigid circular ring, and the tree skirt can only be stowed and stored as a whole, which results in inconvenient stowage and storage of the tree skirt and large footprint.

In view of the problems, the present application is proposed.

### SUMMARY

The present application provides a tree skirt convenient for stowage and storage.

The present application provides the following technical solutions.

A tree skirt convenient for stowage and storage includes:
a skirt piece, where both ends of the skirt piece are connected, and the skirt piece is enclosed to form an inner cavity; and
a support assembly, where the support assembly includes an elastic support ring and a connector, the elastic support ring has a closed ring shape, the elastic support ring is located on an inner surface of the skirt piece, the elastic support ring extends in a circumferential direction of the skirt piece, the connector is detachably connected to the skirt piece, and the elastic support ring is limited between the skirt piece and the connector;
where the elastic support ring is capable of being twisted and folded to form a double- ring structure to reduce a diameter of the elastic support ring.

Optionally, the elastic support ring is formed by bending a single elastic strip so that both ends are in contact and connected and fixed.

Optionally, the both ends of the single elastic strip are connected and fixed in any of the following ways:
the both ends of the single elastic strip are fixed by welding;
the both ends of the single elastic strip are fixed by snap-in; and
the both ends of the single elastic strip are connected and fixed by a connecting body.

Optionally, both sides of the connector are detachably connected to the inner surface of the skirt piece respectively; and
the connector and the skirt piece are enclosed to form a threading cavity, and the single elastic strip is arranged through the threading cavity.

Optionally, one of an inner wall of the skirt piece and the connector is provided with a first loop fastener, and the other is provided with a first hook fastener; and
the first loop fastener and the first hook fastener are fixed by adhering.

Optionally, the support assembly includes a plurality of connectors, the connectors are sequentially spaced apart in an extension direction of the elastic support ring.

Optionally, the skirt piece is in the form of a one-piece body, and the skirt piece is bent so that the both ends are in contact and detachably connected.

Optionally, the both ends of the skirt piece are respectively provided with a second loop fastener and a second hook fastener; and
the second loop fastener and the second hook fastener are fixed by adhering.

Optionally, the skirt piece has main surfaces perpendicular to a thickness direction thereof, and both ends of the main surfaces are respectively provided with the second loop fastener and the second hook fastener; and
the main surfaces at the both ends of the skirt piece are fitted together, and the second loop fastener on the main surface is adhered to the second hook fastener.

Optionally, the both ends of the skirt piece are respectively provided with a width edge;
a plurality of first adhering members are provided on one of the width edges, the first adhering members are sequentially spaced apart along the width edge, and a plurality of extension pieces are provided on the other of the width edges at intervals, and each of the extension pieces is provided with a second adhering member; and
thickness end faces at the both ends of the skirt piece are fitted together, and the second adhering member on each of the extension pieces is adhered to a corresponding first adhering member.

By adopting the above technical solutions, the present application has the following beneficial effects.

The tree skirt of the present application has a simple structure and is convenient to disassemble and assemble, and the elastic support ring is capable of being twisted and folded to form a double-ring structure to reduce a diameter of the elastic support ring, which is convenient for stowage and storage and gives a good user experience.

### BRIEF DESCRIPTION OF THE DRAWINGS

The accompanying drawings, which are incorporated in and constitute a part of the present application, are included to provide a further understanding of the present application. Illustrative embodiments of the present application and the description thereof are included to illustrate the present application, but are not to be construed as unduly limiting the present application. Apparently, the accompanying drawings in the following description are merely some rather than all embodiments of the present application, and a person of ordinary skill in the art may still derive other drawings from these accompanying drawings without creative efforts.

FIG. 1 illustrates a first tree skirt convenient for stowage and storage according to an embodiment of the present application.

FIG. 2 illustrates a view of FIG. 1 observed from another perspective.

FIG. 3 is a partial structural schematic diagram of a second tree skirt convenient for stowage and storage according to an embodiment of the present application.

FIG. 4 is a partial structural schematic diagram of a third tree skirt convenient for stowage and storage according to an embodiment of the present application.

FIG. 5 is a diagram illustrating a state in which an elastic support ring of a tree skirt convenient for stowage and storage is in a twisting and folding process according to an embodiment of the present application.

FIG. 6 is a diagram illustrating a state in which an elastic support ring of a tree skirt is twisted and folded to form a double-ring structure according to an embodiment of the present application.

### DETAILED DESCRIPTION OF THE EMBODIMENTS

In order to make the purpose, technical solutions and advantages of the embodiments of the present application more clear, the technical solutions in the embodiments of the present application will be clearly and completely described below in conjunction with the accompanying drawings in the embodiments of the present application. The embodiments described below are for illustrative purposes only and are not intended to limit the scope of the present application.

In the description of the present application, it should be noted that the terms “upper”, “lower”, “inner”, “outer” and the like indicate orientations or positional relationships based on the orientations or positional relationships shown in the drawings, and are only for convenience of description and simplification of description, but do not indicate or imply that the device or element to be referred must have a specific orientation, be constructed and be operated in a specific orientation, and thus, should not be construed as limiting the present application.

In the description of the present application, it should be noted that, unless expressly and specifically defined otherwise, the terms “mounted” and “connected” are to be interpreted broadly, and may, for example, be fixedly or detachably or integrally connected; may be mechanically connected or electrically connected; or may be directly connected or indirectly connected through an intermediary. The specific meaning of the above terms in the present application can be understood by those of ordinary skill in the art from the specific context.

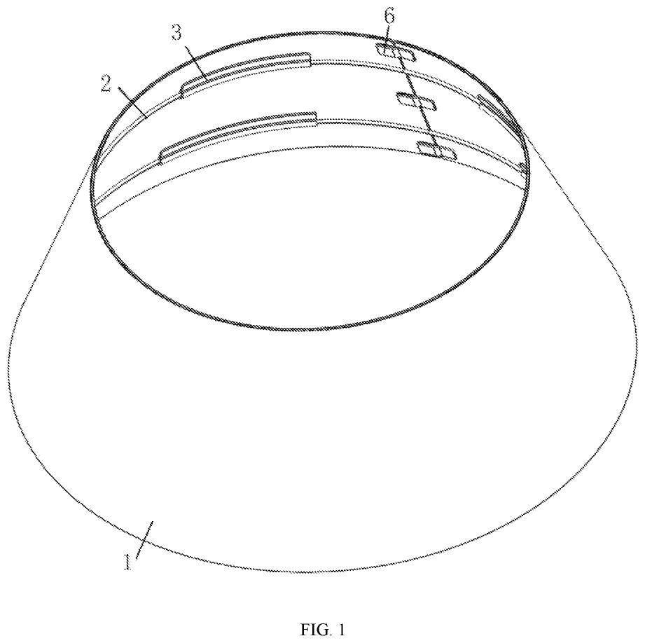

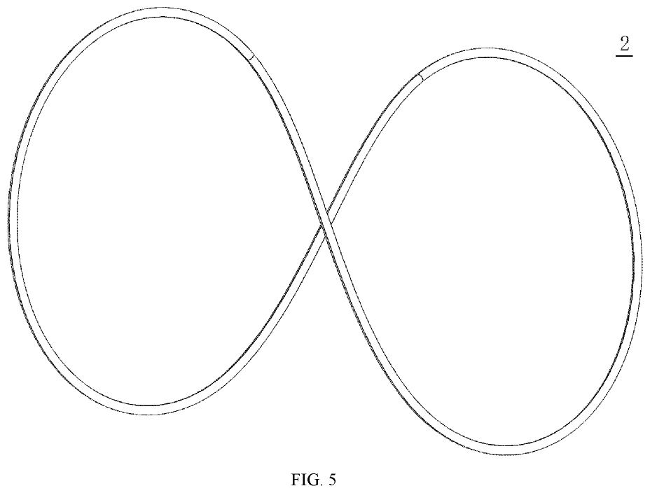

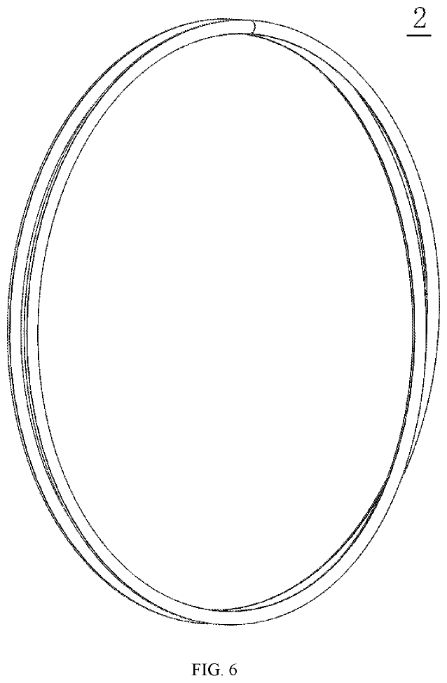

As shown in FIGS. 1-5, an embodiment of the present application provides a tree skirt convenient for stowage and storage, including: a skirt piece 1 and a support assembly. Both ends of the skirt piece 1 are connected, and the skirt piece 1 is enclosed to form an inner cavity. The support assembly includes an elastic support ring 2 and a connector 3, the elastic support ring 2 has a closed ring shape, the elastic support ring 2 is located on an inner surface of the skirt piece 1, the elastic support ring 2 extends in a circumferential direction of the skirt piece 1, the connector 3 is detachably connected to the skirt piece 1, and the elastic support ring 2 is limited between the skirt piece 1 and the connector 3. Here, as shown in FIGS. 5 and 6, the elastic support ring 2 is capable of being twisted and folded to form a double-ring structure to reduce a diameter of the elastic support ring 2.

The skirt piece 1 of the present application may be a flexible sheet body. The elastic support ring 2 has a circular ring shape when not subject to any external force. When the tree skirt needs to be stowed, the skirt piece 1 and the elastic support ring 2 may be disassembled, the skirt piece 1 is folded for stowage, and the elastic support ring 2 is twisted and folded to form the double-ring structure to reduce the diameter of the elastic support ring 2 and facilitate storage.

In some possible embodiments, the elastic support ring 2 is formed by bending a single elastic strip so that both ends are in contact and connected and fixed. In the present embodiment, the single elastic strip may be a steel wire strip or a plastic strip. For example, flexible elastic braces on mosquito nets may be used.

In some possible embodiments, both ends of a single elastic strip are fixed by welding, and the single elastic strip may be a steel wire strip which can maintain a circular ring shape after the both ends are fixed by welding. The both ends of the single elastic strip may also be fixedly connected by a snap-in structure which facilitates disassembly and assembly. Furthermore, one end of the single elastic strip may be provided with a slot, and the other end may be a solid structure, and one end of the solid structure may be tightly inserted into the slot, thus being connected and fixed. The both ends of the single elastic strip may also be connected and fixed by a connecting body. Both ends of the connecting body may be respectively provided with a slot, and the both ends of the single elastic strip may be respectively inserted into the slots at the both ends of the connecting body.

In some possible embodiments, both sides of the connector 3 are detachably connected to the inner surface of the skirt piece 1 respectively, the connector 3 and the skirt piece 1 are enclosed to form a threading cavity, and the single elastic strip is arranged through the threading cavity.

The connector 3 is detachably connected to the skirt piece 1, which facilitates disassembly of the elastic support ring 2 and detachment of the elastic support ring 2 from the skirt piece 1.

In some possible embodiments, one of an inner wall of the skirt piece 1 and the connector 3 is provided with a first loop fastener, and the other is provided with a first hook fastener, and the first loop fastener and the first hook fastener are fixed by adhering. For example, the connector 3 is provided with the first loop fastener on both sides in a width direction, and the inner wall of the skirt piece 1 is provided with the first hook fastener.

In some possible embodiments, the support assembly includes a plurality of connectors 3, the connectors 3 are sequentially spaced apart in an extension direction of the elastic support ring 2. The elastic support ring 2 and the skirt piece 1 may be connected and fixed at different positions by providing the plurality of connectors 3.

In some possible embodiments, the skirt piece 1 is in the form of a one-piece body, and the skirt piece 1 is bent so that the both ends are in contact and detachably connected.

The tree skirt convenient for stowage and storage according to the present application has only one-piece skirt piece 1, which avoids arrangement of a plurality of skirt pieces 1, simplifies the structure, and facilitates assembly, and disassembly and storage.

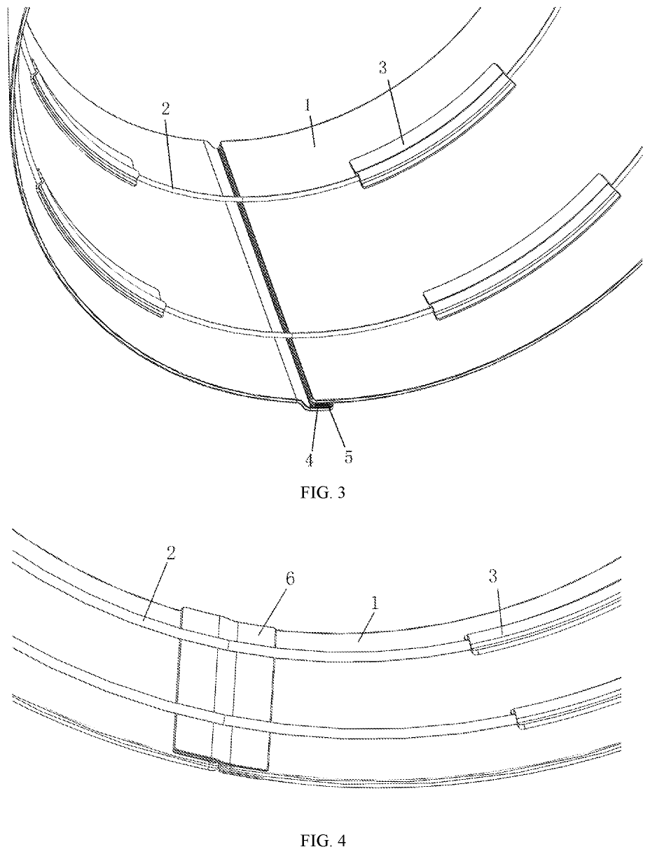

In some possible embodiments, as shown in FIG. 3, the skirt piece 1 is provided at both ends with a second loop fastener 4 and a second hook fastener 5 respectively, and the second loop fastener 4 and the second hook fastener 5 are fixed by adhering.

The skirt piece 1 has main surfaces perpendicular to a thickness direction thereof, and both ends of the main surfaces are respectively provided with the second loop fastener 4 and the second hook fastener 5. The main surfaces at the both ends of the skirt piece 1 are fitted together, and the second loop fastener 4 on the main surface is adhered to the second hook fastener 5. The skirt piece 1 has two main surfaces respectively located on both sides of the skirt piece in the thickness direction. The second loop fastener 4 and the second hook fastener 5 are respectively arranged on the two main surfaces.

In some possible embodiments, as shown in FIG. 4, the both ends of the skirt piece are respectively provided with a width edge, a first adhering member is provided on one of the width edges, and an extension piece 6 is provided on the other of the width edges, a second adhering member is provided on the extension piece 6, thickness end faces at the both ends of the skirt piece are fitted together, and the second adhering member on the extension piece is adhered to the first adhering member. The extension piece 6 is located inside the skirt piece, which does not affect appearance of the skirt piece. One of the first adhering member and the second adhering member may be a loop fastener, and the other may be a hook fastener.

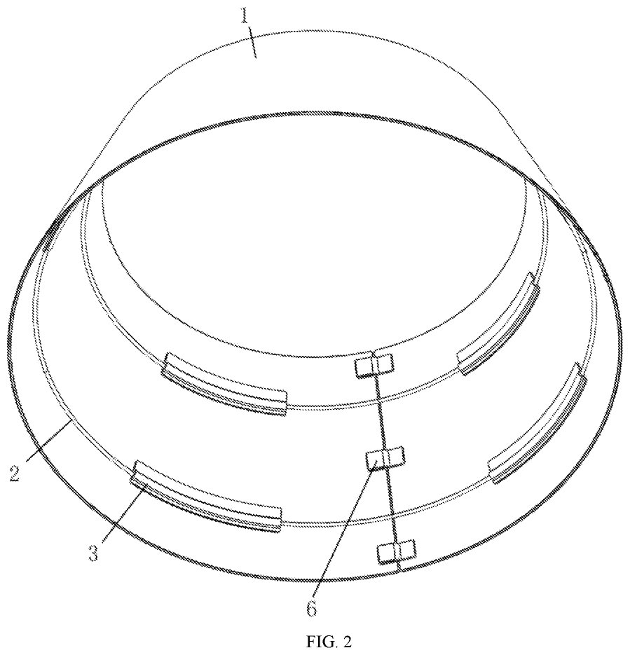

As shown in FIG. 2, the both ends of the skirt piece 1 are respectively provided with a width edge, a plurality of first adhering members are provided on one of the width edges, the first adhering members are sequentially spaced apart along the width edge, and a plurality of extension pieces 6 are provided on the other of the width edges at intervals, and each of the extension pieces 6 is provided with a second adhering member. The thickness end faces at the both ends of the skirt piece 1 are fitted together, and the second adhering member on each of the extension pieces 6 is adhered to the corresponding first adhering member. One of the first adhering member and the second adhering member may be a loop fastener, and the other may be a hook fastener.

The preferred embodiments of the present application disclosed above are intended only to illustrate the present application. It is not intended to elaborate all details of the preferred embodiments, nor is it intended to limit the application to only the specific embodiments described. Obviously, many modifications and variations are possible in light of the above teaching. The embodiments were chosen and described in order to best explain the principles and practical application of the present application and to thereby enable those skilled in the art to best understand and utilize the present application. The present application is to be limited only by the claims, along with their full scope and equivalents.

What is claimed is:

1. A tree skirt convenient for stowage and storage, comprising:
a skirt piece, wherein both ends of the skirt piece are connected, and the skirt piece is enclosed to form an inner cavity; and
a support assembly, wherein the support assembly comprises an elastic support ring and a connector, the elastic support ring has a closed ring shape, the elastic support ring is located on an inner surface of the skirt piece, the elastic support ring extends in a circumferential direction of the skirt piece, the connector is detachably connected to the skirt piece, and the elastic support ring is limited between the skirt piece and the connector; and
wherein the elastic support ring is capable of being twisted and folded to form a double-ring structure to reduce a diameter of the elastic support ring.

2. The tree skirt according to claim 1, wherein the elastic support ring is formed by bending a single elastic strip so that both ends of the skirt piece are in contact and connected and fixed.

3. The tree skirt according to claim 2, wherein the both ends of the single elastic strip are connected and fixed in any of following ways:
the both ends of the single elastic strip are fixed by welding;
the both ends of the single elastic strip are fixed by snap-in;
the both ends of the single elastic strip are fixed by insertion; and
the both ends of the single elastic strip are connected and fixed by a connecting body.

4. The tree skirt according to claim 2, wherein both sides of the connector are detachably connected to the inner surface of the skirt piece respectively; and
the connector and the skirt piece are enclosed to form a threading cavity, and the single elastic strip is arranged through the threading cavity.

5. The tree skirt according to claim 4, wherein one of an inner wall of the skirt piece and the connector is provided with a first loop fastener, and the other is provided with a first hook fastener; and
the first loop fastener and the first hook fastener are fixed by adhering.

6. The tree skirt according to claim 4, wherein the support assembly comprises a plurality of connectors, the connectors are sequentially spaced apart in an extension direction of the elastic support ring.

7. The tree skirt according to claim 1, wherein the skirt piece is in the form of a one-piece body, and the skirt piece is bent so that the both ends of the skirt piece are in contact and detachably connected.

8. The tree skirt according to claim 7, wherein the both ends of the skirt piece are respectively provided with a second loop fastener and a second hook fastener; and
the second loop fastener and the second hook fastener are fixed by adhering.

9. The tree skirt according to claim 8, wherein the skirt piece has main surfaces perpendicular to a thickness direction thereof, and both ends of the main surfaces are respectively provided with the second loop fastener and the second hook fastener; and
the main surfaces at the both ends of the skirt piece are fitted together, and the second loop fastener on the main surface is adhered to the second hook fastener.

10. The tree skirt according to claim 7, wherein the both ends of the skirt piece are respectively provided with a width edge;
a first adhering member is provided on one of the width edges, an extension piece is provided on the other of the width edges, and a second adhering member is provided on the extension piece; and
thickness end faces at the both ends of the skirt piece are fitted together, and the second adhering member on the extension piece is adhered to the first adhering member.
